(19) United States
(12) Patent Application Publication
(10) Pub. No.: US 2005/0136212 A1
(43) Pub. Date: Jun. 23, 2005

(54) Porous interior trim system and method of manufacturing same

(75) Inventors: Barry R. Wyerman, Novi, MI (US); Edward S. Girnys, Livonia, MI (US); Jean-Jacques Katz, Novi, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: Lear Corporation, Southfield, MI (US)

(21) Appl. No.: 10/741,239

(22) Filed: Dec. 19, 2003

(51) Int. Cl. B32B 33/00

(52) U.S. Cl. 428/95

(57) ABSTRACT

A method of making a porous interior trim system for a vehicle includes applying polyethylene particulate to a back side of a porous carpet layer; heating the carpet layer and the particulate; and molding the carpet layer and a porous layer to achieve a desired shape. Moreover, the polyethylene particulate forms a porous coating that is in direct contact with the porous layer.

### BACKGROUND OF THE INVENTION

1. Field of the Invention

The invention relates to a porous interior trim system for a vehicle, and to a method for making the trim system.

2. Background Art

A known method of making an interior trim system, such as a flooring system, involves applying an air-impermeable polyethylene backing layer onto a carpet layer including tufted fibers woven into a spun bond polyester backing. The polyethylene backing layer binds the fibers to the polyester backing, thereby improving durability of the flooring system.

One known method of making an air-permeable flooring system includes applying a latex coating onto a back surface of a carpet layer. The latex coating wicks into the back surface of the carpet layer, thereby creating an air-permeable coating on the carpet layer. A disadvantage of this method, however, is that material and equipment costs are significant.

### SUMMARY OF THE INVENTION

Under the invention, a method of making a porous interior trim system for a vehicle includes applying polyethylene particulate to a back side of a porous carpet layer; heating the carpet layer and the particulate; and molding the carpet layer and a porous layer to achieve a desired shape. Moreover, the polyethylene particulate forms a porous coating that is in direct contact with the porous layer.

Further under the invention, a method of making a contoured, porous sound insulating floor system for use with a motor vehicle includes applying polyethylene particulate to a back side of a porous carpet layer having fibers extending from a primary backing; heating the carpet layer and a porous, generally planar padding layer; and molding the carpet layer and the padding layer to achieve a desired non-planar configuration. The polyethylene particulate forms a porous coating on the back side of the carpet layer that bonds the fibers to the primary backing. The porous coating further bonds the carpet layer to the padding layer such that the porous coating is in direct contact with the padding layer.

A porous sound insulating floor system according to the invention includes a porous carpet layer having a primary backing and multiple fibers attached to the backing. The system further includes a porous coating on the backing and a porous layer in direct contact with the porous coating. The porous coating is formed from polyethylene particulate applied to the backing. Moreover, the porous coating bonds the fibers to the backing and further bonds the porous layer to the carpet layer.

While exemplary products and method of making the products in accordance with the invention are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 is a schematic cross-sectional view of an interior trim system in accordance with the invention, the trim system including a carpet layer, an air-permeable or porous coating attached to the carpet layer, and a porous layer attached to the porous coating; and

FIG. 2 is a schematic view of an arrangement for making the trim system in accordance with the invention.

### DETAILED DESCRIPTION OF THE PREFERRED EMBODIMENT(S)

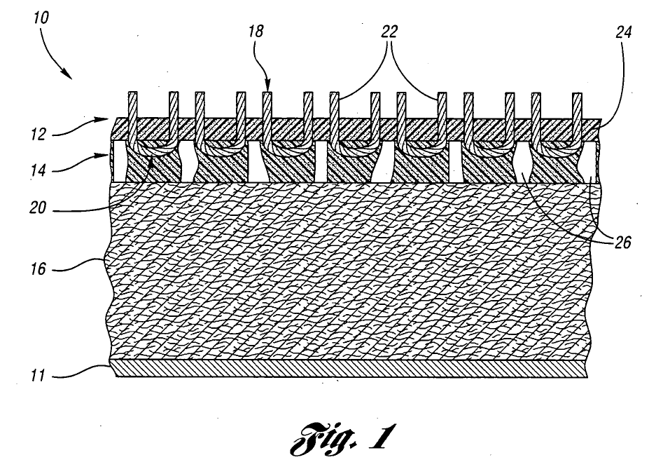

FIG. 1 shows an interior trim system 10, such as a flooring system or carpet system, that is positionable adjacent to a vehicle part 11, such as a floor pan, of a motor vehicle. As additional examples, trim system 10 may be a package shelf covering, trunk liner, door panel covering, or other covering or lining system for use with the vehicle.

The trim system 10 includes an air-permeable, porous carpet layer 12 and an air-permeable, porous coating 14 attached to the carpet layer 12. In the embodiment shown in FIG. 1, the trim system 10 also includes an air-permeable, secondary porous layer 16, such as a padding layer, attached to and in direct contact with the porous coating 14.

The carpet layer 12 has an appearance side or surface 18 that faces toward a vehicle interior, and a concealable back side or surface 20. While the carpet layer 12 may have any suitable configuration, in the embodiment shown in FIG. 1, the carpet layer 12 includes natural and/or synthetic fibers 22, such as tufted nylon fibers, that may be woven into, or otherwise connected to, a primary backing 24, such as a porous, spun bond polyester backing. As another example, carpet layer 12 may include non-woven fibers provided with or without a backing.

The porous coating 14 is formed from polyethylene particulate that is applied on the back surface 20 of the carpet layer 12 and bonded to the carpet layer 12, as explained below in detail. The porous coating 14 includes multiple voids or pores 26 that allow air to pass through the porous coating 14. While the porous coating 14 may have any suitable thickness, in one embodiment of the invention, the porous coating 14 has a thickness in the range of 0.5 to 2 millimeters.

The porous layer 16 may be attached to the carpet layer 12 by the porous coating 14. Furthermore, the porous layer 16 may comprise any suitable material including foam and/or fibers, such as natural and/or synthetic fibers. In the embodiment shown in FIG. 1, the porous layer 16 is a lightweight padding layer that comprises synthetic fibers, such as polyethylene terephthalate fibers, and/or cotton fibers mixed with binder fibers. As another example, the porous layer 16 may comprise one or more paper layers, filter media layers and/or padding layers.

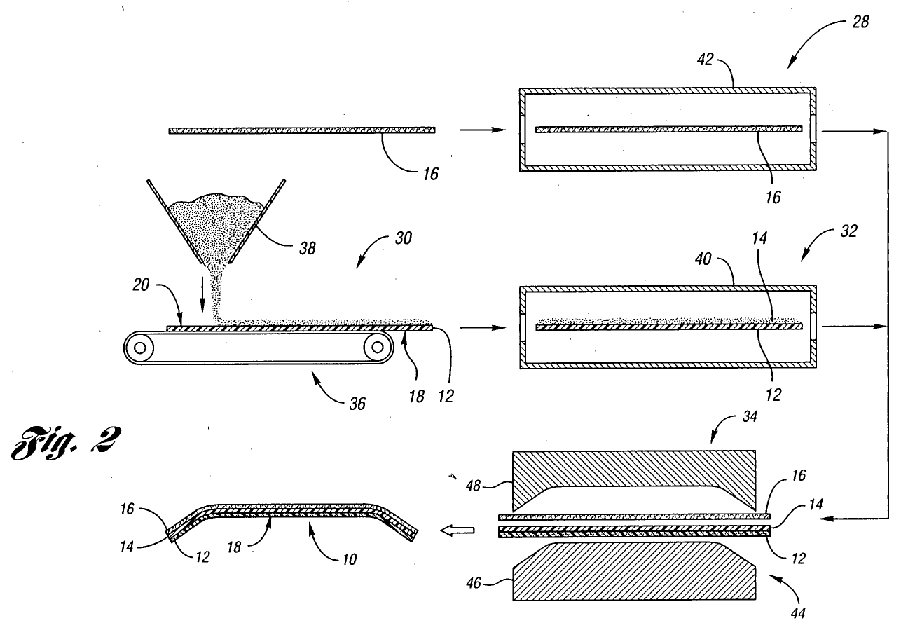

Referring to FIG. 2, a method according to the invention for making the trim system 10 will now be described. While the trim system 10 may be manufactured using any suitable system, FIG. 2 shows an exemplary system or arrangement, such as production line arrangement 28, for manufacturing trim system 10. Production line arrangement 28 includes a particulate application station 30, a heating station 32 and a molding station 34. Furthermore, the stations 30-34 are preferably, but not necessarily, disposed at the same location. The production line arrangement 28 may also include one or more conveyor systems 36 for transporting components within and/or between the stations 30-34.

In the embodiment shown in FIG. 2, carpet layer 12 is provided to the particulate application station 30 as a completed carpet layer that was manufactured either at the same location or at a location different from the location of the production line arrangement 28. The carpet layer 12 may also include a sintered polyethylene coating that was applied at the carpet manufacturing location using a conventional manufacturing process.

At the particulate application station 30, polyethylene particulate, such as powder, chopped fibers, chips, flakes and/or pellets, is applied to the back surface 20 of the carpet layer 12. In the embodiment shown in FIG. 2, for example, polyethylene particulate is deposited from a hopper 38 on the carpet layer 12 so that the loose particulate may make direct contact with the primary backing 24 and the fibers 22 over the entire back surface 20.

Next, the carpet layer 12, with the polyethylene particulate deposited thereon, is transferred to heating station 32 either manually or automatically. The carpet layer 12 is then heated in any suitable manner, such as in a first convection oven 40, such that the polyethylene particulate at least partially melts to form porous coating 14. Porous coating 14 may also seep or otherwise pass into the primary backing 24.

The porous layer 16 may also be heated in any suitable manner at the heating station 32, at the same time as the carpet layer 12, such as in a second convection oven 42. Alternatively, carpet layer 12 and porous layer 16 may be heated together, such as in the same oven.

Next, the carpet layer 12, with porous coating 14, and the porous layer 16 are transferred to molding station 34 where the carpet layer 12 and porous layer 16 may be combined together and molded into a desired shape to form the trim system 10. Moreover, the porous coating 14 forms the interface between the carpet layer 12 and the porous layer 16.

In the embodiment shown in FIG. 2, molding station 34 includes a mold 44 having first and second mold sections 46 and 48, respectively, that each have a non-planar mold surface. The mold 44 is movable between an open position, shown in FIG. 2, and a closed position (not shown) for compressing together the carpet layer 12 and the porous layer 16, and for shaping the carpet layer 12 and the porous layer 16 into a three dimensional molded shape. Alternatively, one or both mold sections 46 and 48 may have a planar mold surface.

One or more additional layers may also be positioned between the mold sections 46 and 48, such that the additional layers may be molded with and attached to the carpet layer 12 and porous layer 16. For example, one or more additional layers may be attached to the porous layer 16 during the molding process, such as with an adhesive. Alternatively, one or more additional layers may be attached to the porous layer 16 prior to positioning the porous layer 16 between the mold sections 46 and 48.

In the embodiment shown in FIG. 2, the porous layer 16 has a planar configuration when initially positioned between the mold sections 46 and 48, such that the porous layer 16 and carpet layer 12 may be simultaneously molded into a desired shape. Alternatively, the porous layer 16 and/or any additional layers may be molded in a separate molding operation such that each layer has a three dimensional molded shape, such as a shape corresponding to the mold surfaces of mold sections 46 and 48, prior to positioning such layer or layers between the mold sections 46 and 48.

Upon sufficiently cooling, either during or after the molding step, the porous coating 14 bonds the fibers 22 to the primary backing 24, thereby locking the fibers 22 in place. The porous coating 14 further bonds the carpet layer 12 to the porous layer 16 such that the porous coating 14 is in direct contact with the porous layer 16. As a result, no additional adhesive is required between the porous coating 14 and the porous layer 16, although additional adhesive may be used.

After the molding step, the trim system 10 may be trimmed, such as with a water jet, knife, or any suitable cutting device, if desired. Alternatively, the trim system 10 may be trimmed during or prior to the molding step.

With the process described above, the carpet layer 12 and the porous layer 16 may be attached together and molded into a desired shape in one molding step. Furthermore, heating of the carpet layer 12 and/or porous layer 16 may also be performed in the mold 44, such that the heating step may be performed simultaneously with or immediately prior to the molding step. For example, a heating fluid such as air or steam may be introduced into the mold 44 to heat the carpet layer 12 and/or the porous layer 16. As another example, one or both mold sections 46 and 48 may be heated in any suitable manner, such as with a heating fluid, so that one or both mold sections 46 and 48 may be used to heat the carpet layer 12 and/or the porous layer 16. In addition, application of the polyethylene particulate to the carpet layer 12 may occur while the carpet layer is positioned in the mold 44.

Under the invention, the entire trim system 10 may be formed as an air-permeable system. For example, trim system 10 may be formed as an air-permeable flooring system that is configured to maximize sound absorption. While each layer of the trim system 10 may have any suitable air-permeability, in one embodiment of the invention, the carpet layer 12 has an airflow resistance in the range of 0 to 500 mks Rayls, the porous coating 14 has an airflow resistance in the range of either 0 to 500 mks Rayls or 2,500 to 10,000 mks Rayls, the porous layer 16 has an airflow resistance in the range of 0 to 500 mks Rayls, and the entire trim system 10 has an airflow resistance in the range of either 0 to 500 mks Rayls or 2,500 to 10,000 mks Rayls.

Furthermore, the air-permeability of the porous coating 14 may be controlled based on the particle size, type and/or amount of the polyethylene particulate applied to the carpet layer 12. As a result, the porous coating 14 may be formed to have any suitable airflow resistance.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A method of making a porous interior trim system for a vehicle, the method comprising:
applying polyethylene particulate to a back side of a porous carpet layer;
heating the carpet layer and the particulate; and
simultaneously molding the carpet layer and a porous layer to achieve a desired shape;
wherein the polyethylene particulate forms a porous coating that is in direct contact with the porous layer.

2. The method of claim 1 wherein the polyethylene particulate comprises polyethylene powder.

3. The method of claim 1 wherein the polyethylene particulate comprises polyethylene chips.

4. The method of claim 1 wherein the polyethylene particulate comprises polyethylene fibers.

5. The method of claim 1 wherein the porous layer comprises a padding layer.

6. The method of claim 5 wherein the porous coating forms the primary attachment means between the carpet layer and the padding layer.

7. The method of claim 1 wherein the porous layer comprises a padding layer and an additional layer having a controlled airflow resistance.

8. The method of claim 1 wherein the applying, heating and molding steps are performed at one location.

9. The method of claim 1 wherein the carpet layer includes fibers extending from a primary backing, and wherein the porous coating bonds the fibers to the primary backing.

10. The method of claim 1 wherein the molding step comprises simultaneously molding the carpet layer and the porous layer into a non-planar configuration.

11. The method of claim 1 wherein the porous layer has a generally planar configuration prior to the molding step.

12. The method of claim 1 wherein the porous layer has a non-planar configuration prior to the molding step.

13. The method of claim 1 wherein the porous coating has an airflow resistance in the range of 2,500 to 10,000 mks Rayls.

14. The method of claim 1 wherein the porous coating has an airflow resistance in the range of 0 to 500 mks Rayls.

15. A method of making a contoured, porous sound insulating floor system for use with a motor vehicle, the method comprising:
applying polyethylene particulate to a back side of a porous carpet layer having fibers extending from a primary backing;
heating the carpet layer and a porous, generally planar padding layer; and
molding the carpet layer and the padding layer to achieve a desired non-planar configuration;
wherein the polyethylene particulate forms a porous coating on the back side of the carpet layer, the porous coating bonding the fibers to the primary backing and further bonding the carpet layer to the padding layer such that the porous coating is in direct contact with the padding layer.

16. The method of claim 14 wherein the polyethylene particulate comprises polyethylene powder.

17. A porous sound insulating floor system for use with a motor vehicle, the system comprising:
a porous carpet layer having a primary backing and multiple fibers attached to the backing;
a porous coating on the backing, the porous coating being formed from polyethylene particulate applied to the backing; and
a porous layer in direct contact with the porous coating;
wherein the porous coating bonds the fibers to the backing and further bonds the porous layer to the carpet layer.

18. The system of claim 17 wherein the porous layer comprises a padding layer.

19. The system of claim 17 wherein the porous layer comprises a padding layer and an additional layer having a controlled airflow resistance.

20. The system of claim 17 wherein the carpet layer, the porous coating and the porous layer have a non-planar configuration.
